(19) United States
(12) Patent Application Publication
(10) Pub. No.: US 2008/0248842 A1
(43) Pub. Date: Oct. 9, 2008

(54) Wireless Earphone Telephone and Communication Method Thereof

(76) Inventor: Cheng Yan Wang, Shenzhen (CN)

Correspondence Address: GLOBAL IP SERVICES, 7285 W. Eagle Court, Winton, CA, 95388, US

(21) Appl. No.: 11/761,993

(22) Filed: Jun. 12, 2007

(30) Foreign Application Priority Data
Apr. 4, 2007 (CN) 200710073821.8

(51) Int. Cl. H04M 1/02

(52) U.S. Cl. 455/575.2

(57) ABSTRACT

The present invention relates to communication equipments, and particularly relates to a kind of wireless earphones telephone and converse method which has common telephone and network telephone function. The present invention comprising a earphone which include host part and a duplex communication earphone with wireless work, and the host part comprising the integration of the common telephone and the network telephone, which can be used to make either common telephone or network telephone, there is a duplex communication logical control chip places inside of the host part, which can carry out a wireless converse between host part and the earphone. Introducing the structure into the six converse methods, keeping one of the network telephone or the wireless telephone converse way functionary while shielding the other way, so as to make sure it assort with each other while have no interfere between the two ways, and the earphone can realize the wireless converse too.

### CROSS REFERENCE TO RELATED PATENT APPLICATION

This application claims the priority of the Chinese patent application No. 200710073821.8, filling date of Apr. 4, 2007.

### FIELD OF THE INVENTION

The present invention relates to communication equipments, and particularly relates to a kind of wireless earphones telephone and converse method which has common telephone and network telephone function.

### BACKGROUND OF THE INVENTION

Conventional wireless telephone mostly adopt to cordless telephone, with telephone receiver to listen. People need to hold on the telephone receiver to make a phone call and is inconvenient to do other things.

Moreover, the existing telephone system mostly adopts telephone line to carry on converse; there hasn't appeared a communication equipment which can be applied in the telephone line and network telephone in the meantime.

### SUMMARY OF THE INVENTION

A main feature of the present invention is to provide existing technical circumstance a kind of wireless earphones telephone and converse method which has common telephone and network telephone function.

To achieve the above-mentioned features, the present invention comprising a earphone which include host part and a duplex communication earphone with wireless work, and the host part comprising the integration of the common telephone and the network telephone, which can be used to make either common telephone or network telephone, there is a duplex communication logical control chip places inside of the host part, which can carry out a wireless converse between host part and the earphone.

The host circuit of the host part comprises a main telephone chip connected the telephone line, the main telephone chip connected the telephone communication circuit, and the telephone communication circuit connected the duplex communication logical control chip, the duplex communication logical control chip controls the logical control circuit, and the logical control circuit connected the main chip, telephone communication circuit, the duplex communication logical control chip, a frequency power amplifier and voice circuit, moreover control each unit circuit to realization corresponding function, the frequency power amplifier and the voice circuit connected the computer by computer's frequency input and frequency output, the power supply provide electricity respectively for each circuit parts above-mentioned.

The frequency input and frequency output connected the computer with USB sound card, and it uses the USB interface as the interface of the frequency input and frequency output.

As above-mentioned, the duplex communication logical control chip can be actualized either by the Bluetooth commonly in market, or by chips of 1.8 G, 2.4 G, 5.8 G frequency.

There are caller ID display screen and caller ID display circuit connected to the mentioned telephone main chip.

The duplex communication logical control chip comprising single chip or multi-chip.

The logical control circuit including eight bidirectional analog switches, three logical AND gates and multi-Schmidt triggers, the duplex communication logical control chip, which connected the logical control circuit, is the Bluetooth chip, and the idiographic way of the connection as follows:

The input end of the first switch connected telephone circuit, its control end connected the control end of the seventh switch, and the other end of the first switch has two parts, the one is connected the VCC output end of the telephone main chip by resistance R43 and resistance R44, an other is connected the grounded microphone, and the microphone connected capacitance C38 in series, then parallel connection with resistance R43.

The one end of the second switch connected one end of the first switch, its control end connected the control end of the eighth switch, and the anther end of the second switch connected the frequency output.

One end of the third switch connected local telephone circuit, its control end divide into three parts, one part connected the control end of the sixth switch, the other connected the main local telephone chip, and the last one connected the duplex communication logical control chip, then the other end of the third switch connected the duplex communication logical control chip with a capacitance C42.

One end of the fourth switch connected the local telephone chip with a connection circuit, its control end divide into two parts, one part connected the control end of the fifth switch, the other part connected the output end of the logical AND gate IC7C, the other end of the fourth switch connected one end of the third switch, then connected duplex communication logical control chip with capacitance C42.

One end of the fifth switch connected the frequency output, its control end connected the control end of the fourth switch, then connected the logical AND gate IC7C, the other end of the fifth switch parallel connected one end of the sixth switch, then connected duplex communication logical control chip with a capacitance C43.

One end of the sixth switch connected the telephone communication circuit, its control end divided into two parts, one connected the main telephone chip, and the other connected the duplex communication logical control chip, the other end of the sixth connected capacitance C43 in series, then connected the duplex communication logical control chip.

One end of the seventh switch connected the telephone communication circuit, its control end connected the control end of the first switch, and the other end of the seventh switch connected the frequency power amplifier and voice circuit.

One end of the eighth switch connected the frequency input end of the computer, its control end connected the control end of the second switch, the other end of the eighth switch parallel connected the output end of the seventh switch, then connected the frequency power amplifier and voice circuit.

The output end of the logical AND gate IC7D connected the control end of the first switch, one input end of the logical AND gate IC7D divided onto two parts, one connected the duplex communication logical control chip, and the other connected the telephone main chip with the plastic circuit, the other input end of the logical AND gate IC7D divided onto two parts also, one connected the input end of the logical AND gate IC7A, and the other connected the input end of the Schmidt trigger IC8C.

The input end of the logical AND gate IC7A connected the control end of the eighth switch, one input end of the logical AND gate IC7D divided onto two parts, one connected the input end of the logical AND gate IC7C, and the other connected the telephone main chip with the plastic circuit, the other input end of the logical AND gate IC7A connected the input end of the Schmidt trigger IC8C.

The output end of the logical AND gate IC7C connected both the control end of the fourth switch and the control end of the fifth switch, one of its input end connected the input end of the logical AND gate IC7A, and the other input end connected the Schmidt trigger IC8C, the Schmidt trigger IC8B, the diode C20, the Schmidt trigger IC8A, and the capacitance C45 in series, then connected the collector of a audion Q12, the other side of the collector of the audion Q12 connected the power supply VCC of the main local telephone chip with resistance R59, end the light-emitting-diode LED9, the emitter end of the audion Q12 connected to the earth, and the base end of the audion Q12 connected the duplex communication logical control chip.

The converse method of the present invention as follows:
Logical control circuit makes the host circuit into waiting state while both the frequency power amplifier and the voice circuit connected the computer, when the MIC connected the computer, it can make communication with computer without holding up the earphone, and the embodiment of the control way as follows:
The first switch is at low level state, the MIC signal can not turn into the telephone line, and the other signal can't be connected contrarily.
The second switch is at high level state, the MIC signal can turn into the computer while connected contrarily to the fifth switch, the control end is at the low level state, end.
The third switch is at low level state, the signal from the earphone to the mainboard of the Bluetooth is ended.
The fourth switch is at low level state, the LINE signal of the computer can't turn into the input end of the mainboard of the Bluetooth.
The fifth switch is at low level state, the MIC signal which is outputted from the Bluetooth to the computer, is ended.
The sixth switch is at low level state, the signal which is outputted from the Bluetooth to the telephone, is ended.
The seventh switch is at low level state, while without RING signal.
The eighth switch is at high level state, the LINE signal get through the power amplifier, and the feedback signal connected contrarily to the seventh switch, the control end is at low level state, end.

Logical control circuit controls the host circuit into the conversing state, the embodiment of the control way as follows:
The first switch is at low level state, the MIC signal can not turn into the telephone line.
The second switch is at low level state, the MIC signal can't turn into the computer.
The third switch is at low level state, the input signal from the earphone to the Bluetooth is ended.
The fourth switch is at high level state, the LINE signal of the computer turn into the mainboard of the Bluetooth, the signal connected contrarily to the third switch, and the control end is at low level state, end.
The fifth switch is at high level state, the MIC signal, which is outputted from the Bluetooth to the computer, gets through, the signal connected contrarily to the second switch, and the control end is at low level state, end, the signal connected contrarily to the sixth switch, and the control end is at low level state, end.
The sixth switch is at low level state, the signal which is outputted from the Bluetooth to the telephone, is ended.
The seventh switch is at low level state, the telephone signal and the RING signal is ended.
The eighth switch is at low level state, the LINE signal from the computer to the power amplifier is switched off.

Logical control circuit controls the host circuit into waiting state, when the telephone be pulled, the embodiment of the control way as follows:
The first switch is at high level state, the MIC signal turns into the telephone line, the signal connected contrarily to the second switch, and at the low level state, end.
The second switch is at low level state, the signal is ended.
The third switch is at low level state, the signal from the earphone to the Bluetooth is ended.
The fourth switch is at low level state, the signal is ended.
The fifth switch is at low level state, the signal is ended.
The sixth switch is at low level state, the signal is ended.
The seventh switch is at high level state, the telephone signal turns into the power amplifier, it's impactful when the without holding up the earphone.
The eighth switch is at low level state, the signal is ended.

Logical control circuit controls the host circuit working with Bluetooth state, when the telephone be pulled, the embodiment of the control way as follows:
The first switch is at low level state, the signal is ended.
The second switch is at low level state, the signal is ended.
The third switch is at high level state, the signal from the earphone turns into the mainboard of the Bluetooth.
The fourth switch is at low level state, the signal is ended.
The fifth switch is at low level state, the signal is ended.
The sixth switch is at high level state, the signal from the Bluetooth turns into the telephone line.
The seventh switch is at low level state, the signal is ended.
The eighth switch is at low level state, the signal is ended.

Logical control circuit controls the host circuit into waiting state when calling in, the embodiment of the control way as follows:
The first switch is at high level state, the MIC signal is impactful to the telephone line.
The second switch is at low level state, the MIC signal to the computer is ended.
The third switch is at high level state, the signal from the telephone turns into the Bluetooth is ended.
The fourth switch is at low level state, the LINE signal from the computer turns into the Bluetooth is ended.
The fifth switch is at low level state, the signal from the Bluetooth to the computer is ended.
The sixth switch is at low level state, the signal from the Bluetooth turns into the telephone line is ended.
The seventh switch is at high level state, the telephone signal is impactful while it turning into power amplifier.
The eighth switch is at low level state, the computer signal is ended, while it turning into power amplifier.

Logical control circuit controls the host circuit work with Bluetooth state when calling in, the embodiment of the control way as follows:
The first switch is at low level state, the MIC signal is ended while it turning into the telephone line.
The second switch is at low level state, the MIC signal to the computer is ended.
The third switch is at high level state, the signal from the telephone turns into the Bluetooth is inpactful.
The fourth switch is at low level state, the LINE signal from the computer turns into the bluetooth is ended.
The fifth switch is at low level state, the signal from the Bluetooth to the computer is ended.
The sixth switch is at high level state, the signal from the Bluetooth turns into the telephone line is impactful.
The seventh switch is at low level state, the telephone signal is ended while it turning into power amplifier.
The eighth switch is at low level state, the computer signal is ended, while it turning into power amplifier.

Introducing the structure as above-mentioned, the telephone of the present invention adopts the wireless earphone as the receiver, while people make a call more conveniently, they draw the earphone on, without holding up the telephone. The present invention also can make network telephone, using the wireless earphone to do it. The converse method of the present invention carries by the logical control software when it controls the state of the logical control circuit, and always keeping one converse way functionary while shielding the other way, so as to make sure there have no interfere between the two ways.

### DESCRIPTION OF THE DRAWINGS

FIG. 1 is a structure frame diagram of the host circuit according to a first embodiment of the present invention.

FIG. 2 is a structure frame diagram of the host circuit according to a second embodiment of the present invention.

FIG. 3 is a structure frame diagram of the earphone circuit according to the present invention.

FIG. 4 is a idiographic electric circuit principle diagram of the host circuit according to the present invention.

FIG. 4a is a enlarge view of the part 4a of the FIG. 4.

FIG. 4b is a enlarge view of the part 4b of the FIG. 4.

FIG. 4c is a enlarge view of the part 4c of the FIG. 4.

FIG. 4d is a enlarge view of the part 4d of the FIG. 4.

### DETAILED DESCRIPTION OF THE INVENTION

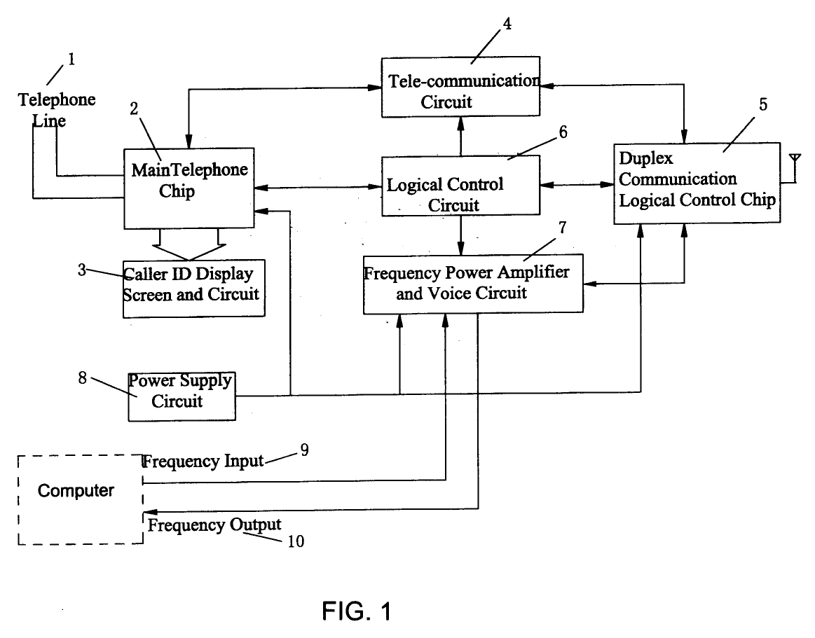

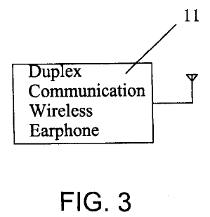

Referring from FIG. 1 to FIG. 4, the present invention comprising host part and a duplex communication earphone11 with wireless work, and the host part comprising the integration of the common telephone and the network telephone, which can be used to make either common telephone or network telephone, there is a duplex communication logical control chip5 places inside of the host part, which carry out a wireless converse between host part and the earphone 11.

Referring to FIG. 1, the host circuit of the host part comprises a main telephone chip2 connected the telephone line1, the main telephone chip2 connected the telephone communication circuit4, and the tele-communication circuit4 connected the duplex communication logical control chip5, the duplex communication logical control chip5 controls the logical control circuit6, and the logical control circuit6 connected the main chip2, telephone communication circuit4, the duplex communication logical control chip5, a frequency power amplifier and voice circuit7, moreover control each unit circuit to realization corresponding function, the frequency power amplifier and the voice circuit7 connected the computer with computer's frequency input9 and frequency output10, the power supply8 provide electricity respectively for each circuit parts above-mentioned.

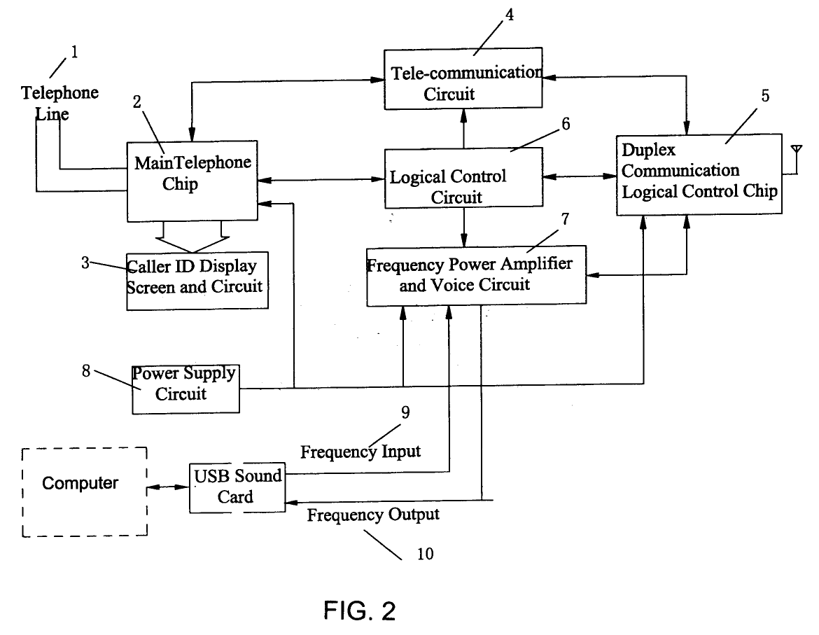

Referring to FIG. 2, the embodiment of the present invention adopts a USB faucet, the frequency input9 and frequency output10 connected the computer with USB sound card12, and it uses the USB interface as the interface of the frequency input9 and frequency output10.

As above-mentioned, the duplex communication logical control chip5 can be actualized either by the Bluetooth commonly in market, or by chips of 1.8 G, 2.4 G, 5.8 G frequency.

There are caller ID display screen and caller ID display circuit3 connected to the mentioned telephone main chip2.

The duplex communication logical control chip5 comprising single chip or multi-chip.

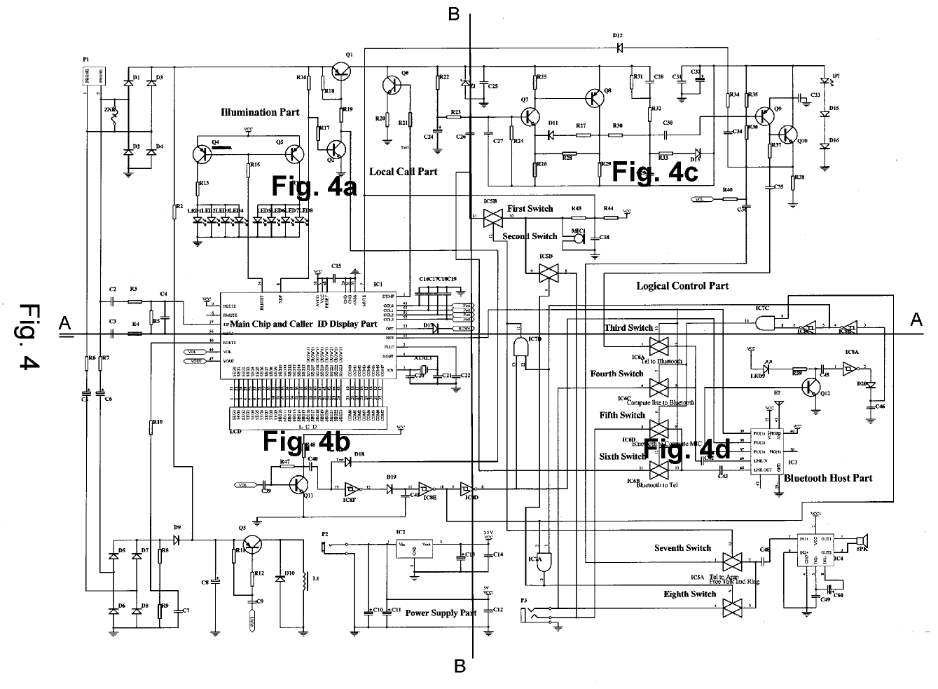

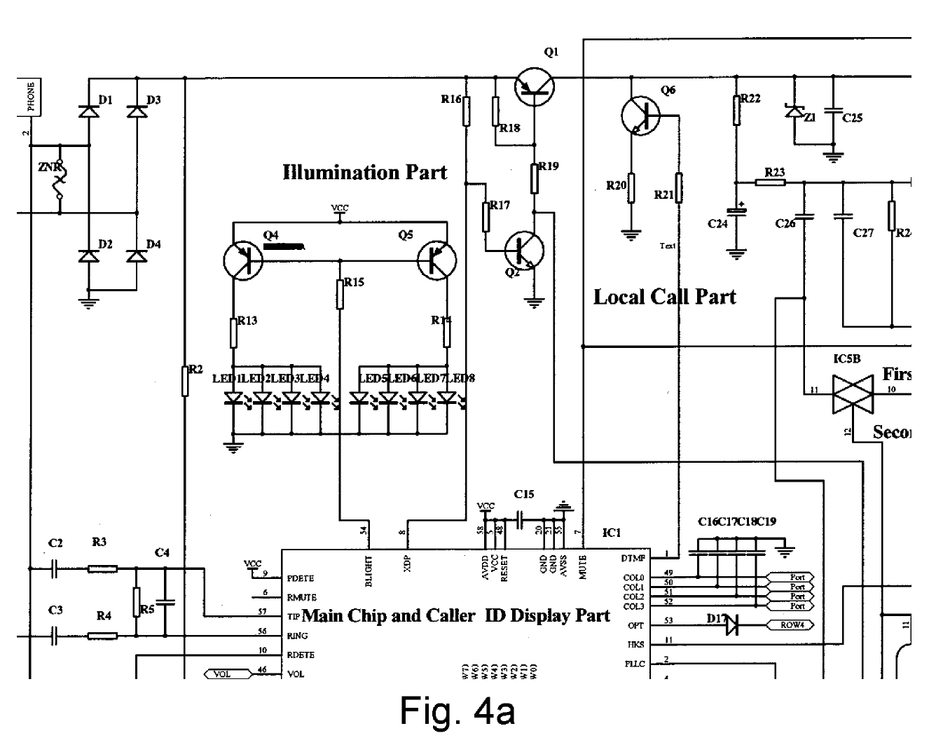

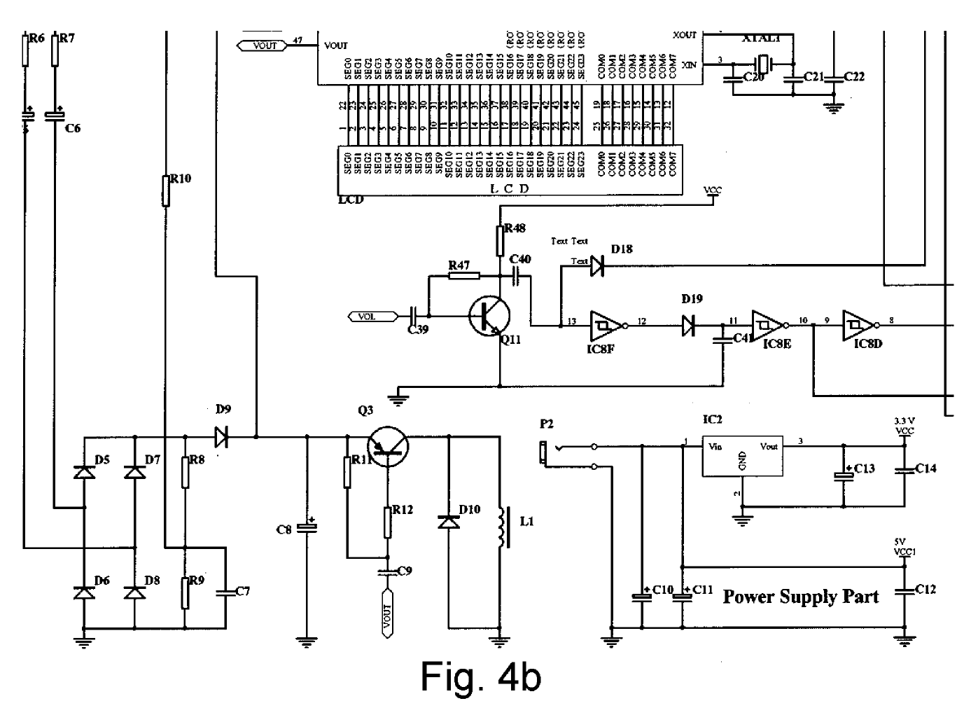

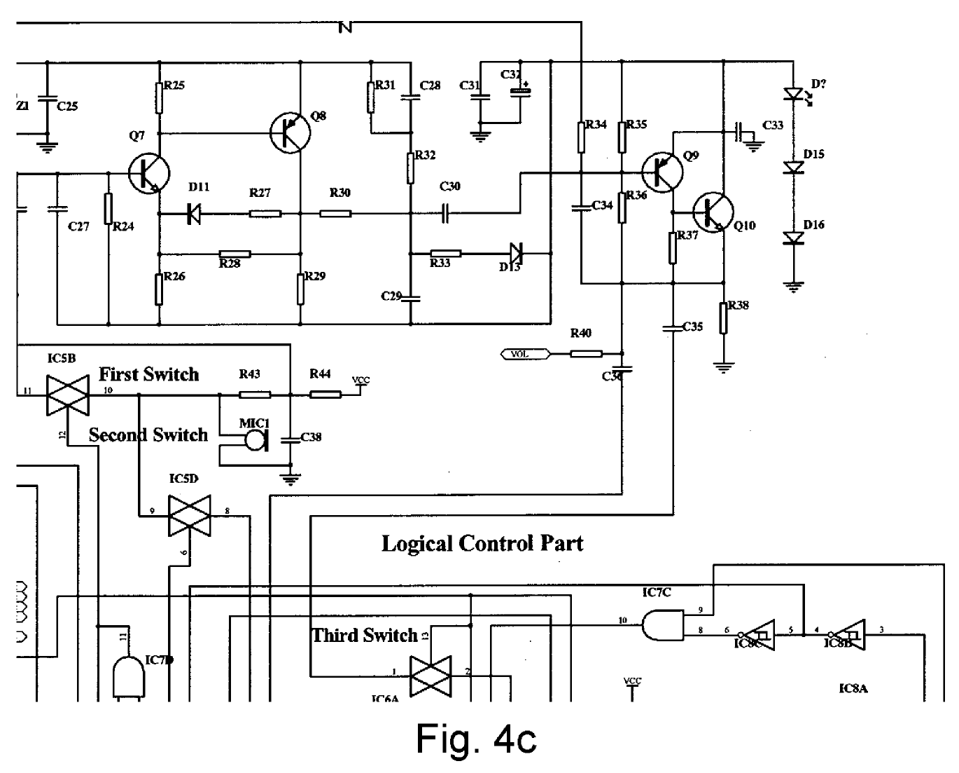

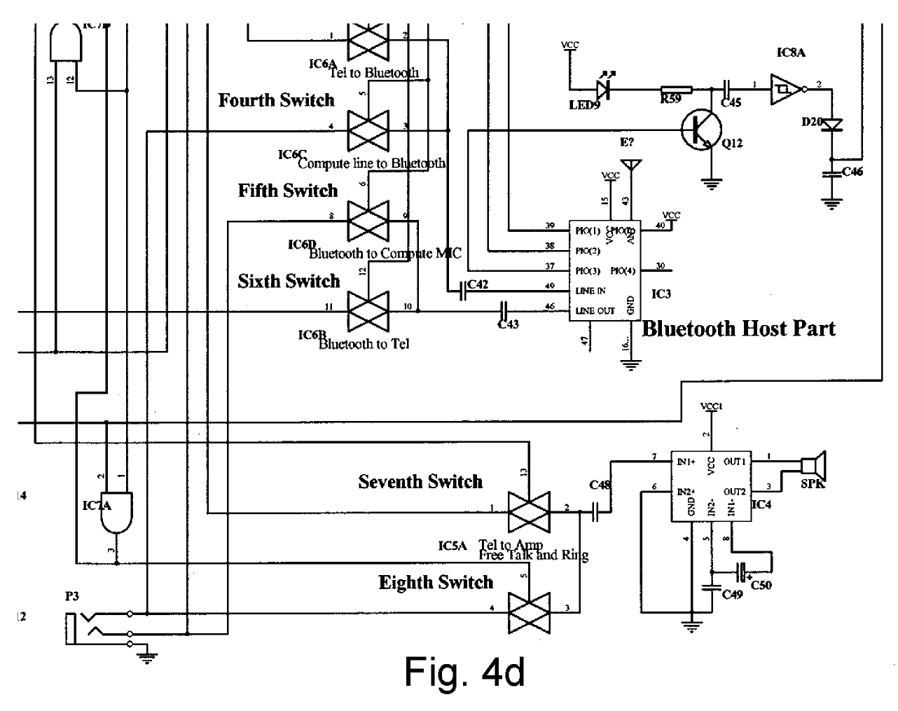

Referring to a idiographic electric circuit principle diagram FIG. 4, the logical control circuit6 including eight bidirectional analog switches, three logical AND gates and multi-Schmidt triggers, the duplex communication logical control chip5, which connected the logical control circuit6, is the bluetooth chip, and the idiographic way of the connection as follows:

The input end of the first switch connected telephone circuit, its control end connected the control end of the seventh switch, and the other end of the first switch has two parts, the one is connected the VCC output end of the telephone main chip by resistance R43 and resistance R44, an other is connected the grounded microphone, and the microphone connected capacitance C38 in series, then parallel connection with resistance R43.

The one end of the second switch connected one end of the first switch, its control end connected the control end of the eighth switch, and the anther end of the second switch connected the frequency output end10.

One end of the third switch connected local telephone circuit, its control end divide into three parts, one part connected the control end of the sixth switch, the other connected the main local telephone chip2, and the last one connected the duplex communication logical control chip5, then the other end of the third switch connected the duplex communication logical control chip5 with a capacitance C42.

One end of the fourth switch connected the local telephone chip2 with a connection circuit, its control end divide into two parts, one part connected the control end of the fifth switch, the other part connected the output end of the logical AND gate IC7C, the other end of the fourth switch connected one end of the third switch, then connected duplex communication logical control chip5 with capacitance C42.

One end of the fifth switch connected the frequency output10, its control end connected the control end of the fourth switch, then connected the logical AND gate IC7C, the other end of the fifth switch parallel connected one end of the sixth switch, then connected duplex communication logical control chip5 with a capacitance C43.

One end of the sixth switch connected the telephone communication circuit4, its control end divided into two parts, one connected the main telephone chip2, and the other connected the duplex communication logical control chip5, the other end of the sixth connected capacitance C43 in series, then connected the duplex communication logical control chip5.

One end of the seventh switch connected the telephone communication circuit4, its control end connected the control end of the first switch, and the other end of the seventh switch connected the frequency power amplifier and voice circuit7.

One end of the eighth switch connected the frequency input end 9 of the computer, its control end connected the control end of the second switch, the other end of the eighth switch parallel connected the output end of the seventh switch, then connected the frequency power amplifier and voice circuit7.

The output end of the logical AND gate IC7D connected the control end of the first switch, one input end of the logical AND gate IC7D divided onto two parts, one connected the duplex communication logical control chip5, and the other connected the telephone main chip2 with the plastic circuit, the other input end of the logical AND gate IC7D divided onto two parts also, one connected the input end of the logical AND gate IC7A, and the other connected the input end of the Schmidt trigger IC8C.

The input end of the logical AND gate IC7A connected the control end of the eighth switch, one input end of the logical AND gate IC7D divided onto two parts, one connected the input end of the logical AND gate IC7C, and the other connected the telephone main chip2 with the plastic circuit, the other input end of the logical AND gate IC7A connected the input end of the Schmidt trigger IC8C.

The output end of the logical AND gate IC7C connected both the control end of the fourth switch and the control end of the fifth switch, one of its input end connected the input end of the logical AND gate IC7A, and the other input end connected the Schmidt trigger IC8C, the Schmidt trigger IC8B, the diode C20, the Schmidt trigger IC8A, and the capacitance C45 in series, then connected the collector of a audion Q12, the other side of the collector of the audion Q12 connected the power supply VCC of the main local telephone chip with resistance R59, end the light-diode-diode LED9, the emitter end of the audion Q12 connected to the earth, and the base end of the audion Q12 connected the duplex communication logical control chip5.

When actualizing the embodiment as the structure frame diagram of FIG. 4, the converse method of the present invention has six state, the first as follows:
Logical control circuit6 makes the host circuit into waiting state while both the frequency power amplifier and the voice circuit7 connected the computer, when the MIC connected the computer, it can make communication with computer without holding up the earphone, and the embodiment of the control way as follows:
The first switch is at low level state, the MIC signal can not turn into the telephone line, and the other signal can't be connected contrarily.
The second switch is at high level state, the MIC signal can turn into the computer while connected contrarily to the fifth switch, the control end is at the low level state, end.
The third switch is at low level state, the signal from the earphone to the mainboard of the Bluetooth is ended.
The fourth switch is at low level state, the LINE signal of the computer can't turn into the input end of the mainboard of the Bluetooth.
The fifth switch is at low level state, the MIC signal, which is outputted from the Bluetooth to the computer, is ended.
The sixth switch is at low level state, the signal, which is outputted from the Bluetooth to the telephone, is ended.
The seventh switch is at low level state, while without RING signal.
The eighth switch is at high level state, the LINE signal get through the power amplifier, and the feedback signal connected contrarily to the seventh switch, the control end is at low level state, end.

Second, logical control circuit6 controls the host circuit into the conversing state, the embodiment of the control way as follows:
The first switch is at low level state, the MIC signal can not turn into the telephone line.
The second switch is at low level state, the MIC signal can't turn into the computer.
The third switch is at low level state, the input signal from the earphone to the Bluetooth is ended.
The fourth switch is at high level state, the LINE signal of the computer turn into the mainboard of the Bluetooth, the signal connected contrarily to the third switch, and the control end is at low level state, end.
The fifth switch is at high level state, the MIC signal, which is outputted from the Bluetooth to the computer, gets through, the signal connected contrarily to the second switch, and the control end is at low level state, end, the signal connected contrarily to the sixth switch, and the control end is at low level state, end.
The sixth switch is at low level state, the signal, which is outputted from the Bluetooth to the telephone, is ended.
The seventh switch is at low level state, the telephone signal and the RING signal is ended.
The eighth switch is at low level state, the LINE signal from the computer to the power amplifier is switched off.

Third, logical control circuit6 controls the host circuit into waiting state, when the telephone be pulled, the embodiment of the control way as follows:
The first switch is at high level state, the MIC signal turns into the telephone line, the signal connected contrarily to the second switch, and at the low level state, end.
The second switch is at low level state, the signal is ended.
The third switch is at low level state, the signal from the earphone to the Bluetooth is ended.
The fourth switch is at low level state, the signal is ended.
The fifth switch is at low level state, the signal is ended.
The sixth switch is at low level state, the signal is ended.
The seventh switch is at high level state, the telephone signal turns into the power amplifier, it's impactful when the without holding up the earphone.
The eighth switch is at low level state, the signal is ended.

Fourth, logical control circuit (6) controls the host circuit working with Bluetooth state, when the telephone be pulled, the embodiment of the control way as follows:
The first switch is at low level state, the signal is ended.
The second switch is at low level state, the signal is ended.
The third switch is at high level state, the signal from the earphone turns into the mainboard of the Bluetooth.
The fourth switch is at low level state, the signal is ended.
The fifth switch is at low level state, the signal is ended.
The sixth switch is at high level state, the signal from the Bluetooth turns into the telephone line.
The seventh switch is at low level state, the signal is ended.
The eighth switch is at low level state, the signal is ended.

Fifth, logical control circuit6 controls the host circuit into waiting state when calling in, the embodiment of the control way as follows:
The first switch is at high level state, the MIC signal is impactful to the telephone line.
The second switch is at low level state, the MIC signal to the computer is ended.
The third switch is at high level state, the signal from the telephone turns into the Bluetooth is ended.
The fourth switch is at low level state, the LINE signal from the computer turns into the Bluetooth is ended.
The fifth switch is at low level state, the signal from the Bluetooth to the computer is ended.
The sixth switch is at low level state, the signal from the Bluetooth turns into the telephone line is ended.
The seventh switch is at high level state, the telephone signal is impactful while it turning into power amplifier.
The eighth switch is at low level state, the computer signal is ended, while it turning into power amplifier.

Sixth, logical control circuit6 controls the host circuit work with Bluetooth state when calling in, the embodiment of the control way as follows:
The first switch is at low level state, the MIC signal is ended while it turning into the telephone line.
The second switch is at low level state, the MIC signal to the computer is ended.
The third switch is at high level state, the signal from the telephone turns into the Bluetooth is inpactful.
The fourth switch is at low level state, the LINE signal from the computer turns into the bluetooth is ended.
The fifth switch is at low level state, the signal from the Bluetooth to the computer is ended.
The sixth switch is at high level state, the signal from the Bluetooth turns into the telephone line is impactful.
The seventh switch is at low level state, the telephone signal is ended while it turning into power amplifier.
The eighth switch is at low level state, the computer signal is ended, while it turning into power amplifier.

What is claimed is:

1. A wireless earphone, comprising host part and a duplex communication earphone(11) with wireless work, and the host part comprising the integration of the common telephone and the network telephone, which can be used to make either common telephone or network telephone, there is a duplex communication logical control chip(5) places inside of the host part, which carry out a wireless converse between host part and the earphone(11).

2. The wireless earphone as claimed in claim 1, the host circuit of the host part comprises a main telephone chip(2) connected the telephone line(1), the main telephone chip(2) connected the telephone communication circuit(4), and the tele-communication circuit(4) connected the duplex communication logical control chip(5), the duplex communication logical control chip(5) controls the logical control circuit(6), and the logical control circuit6 connected the main chip(2), telephone communication circuit(4), the duplex communication logical control chip(5), a frequency power amplifier and voice circuit(7), moreover control each unit circuit to realization corresponding function, the frequency power amplifier and the voice circuit(7) connected the computer with computer's frequency input(9) and frequency output(10), the power supply(8) provide electricity respectively for each circuit parts above-mentioned.

3. The wireless earphone as claimed in claim 2, the frequency input(9) and frequency output(10) connected the computer with USB sound card(12), and it uses the USB interface as the interface of the frequency input(9) and frequency output(10).

4. The wireless earphone as claimed in claim 2, the duplex communication logical control chip(5) can be actualized either by the Bluetooth commonly in market, or by chips of 1.8 G, 2.4 G, 5.8 G frequency.

5. The wireless earphone as claimed in claim 2, there are caller ID display screen and caller ID display circuit(3) connected to the mentioned telephone main chip(2).

6. The wireless earphone as claimed in claim 2, the duplex communication logical control chip(5) comprising single chip or multi-chip.

7. The wireless earphone as claimed in claim 2, the logical control circuit(6) including eight bidirectional analog switches, three logical AND gates and multi-Schmidt triggers, the duplex communication logical control chip(5), which connected the logical control circuit(6), is the bluetooth chip, and the idiographic way of the connection as follows:
The input end of the first switch connected telephone circuit, its control end connected the control end of the seventh switch, and the other end of the first switch has two parts, the one is connected the VCC output end of the telephone main chip by resistance R43 and resistance R44, an other is connected the grounded microphone, and the microphone connected capacitance C38 in series, then parallel connection with resistance R43;
The one end of the second switch connected one end of the first switch, its control end connected the control end of the eighth switch, and the anther end of the second switch connected the frequency output end(10);
One end of the third switch connected local telephone circuit, its control end divide into three parts, one part connected the control end of the sixth switch, the other connected the main local telephone chip(2), and the last one connected the duplex communication logical control chip(5), then the other end of the third switch connected the duplex communication logical control chip(5) with a capacitance C42;
One end of the fourth switch connected the local telephone chip(2) with a connection circuit, its control end divide into two parts, one part connected the control end of the fifth switch, the other part connected the output end of the logical AND gate IC7C, the other end of the fourth switch connected one end of the third switch, then connected duplex communication logical control chip(5) with capacitance C42;
One end of the fifth switch connected the frequency output(10), its control end connected the control end of the fourth switch, then connected the logical AND gate IC7C, the other end of the fifth switch parallel connected one end of the sixth switch, then connected duplex communication logical control chip(5) with a capacitance C43;
One end of the sixth switch connected the telephone communication circuit(4), its control end divided into two parts, one connected the main telephone chip(2), and the other connected the duplex communication logical control chip(5), the other end of the sixth connected capacitance C43 in series, then connected the duplex communication logical control chip(5);
One end of the seventh switch connected the telephone communication circuit (4), its control end connected the control end of the first switch, and the other end of the seventh switch connected the frequency power amplifier and voice circuit(7);
One end of the eighth switch connected the frequency input end(9) of the computer, its control end connected the control end of the second switch, the other end of the eighth switch parallel connected the output end of the seventh switch, then connected the frequency power amplifier and voice circuit(7);
The output end of the logical AND gate IC7D connected the control end of the first switch, one input end of the logical AND gate IC7D divided onto two parts, one connected the duplex communication logical control chip(5), and the other connected the telephone main chip(2) with the plastic circuit, the other input end of the logical AND gate IC7D divided onto two parts also, one connected the input end of the logical AND gate IC7A, and the other connected the input end of the Schmidt trigger IC8C;
The input end of the logical AND gate IC7A connected the control end of the eighth switch, one input end of the logical AND gate IC7D divided onto two parts, one connected the input end of the logical AND gate IC7C, and the other connected the telephone main chip(2) with the plastic circuit, the other input end of the logical AND gate IC7A connected the input end of the Schmidt trigger IC8C;
The output end of the logical AND gate IC7C connected both the control end of the fourth switch and the control end of the fifth switch, one of its input end connected the input end of the logical AND gate IC7A, and the other input end connected the Schmidt trigger IC8C, the Schmidt trigger IC8B, the diode C20, the Schmidt trigger IC8A, and the capacitance C45 in series, then connected the collector of a audion Q12, the other side of the collector of the audion Q12 connected the power supply VCC of the main local telephone chip with resistance R59, end the light-diode-diode LED9, the emitter end of the audion Q12 connected to the earth, and the base end of the audion Q12 connected the duplex communication logical control chip(5).

8. A converse method of the wireless earphone as claimed in claim 7, logical control circuit(6) makes the host circuit into waiting state while both the frequency power amplifier and the voice circuit7 connected the computer, when the MIC connected the computer, it can make communication with computer without hold up the earphone, and the embodiment of the control way as follows:
The first switch is at low level state, the MIC signal can not turn into the telephone line, and the other signal can't be connected contrarily;
The second switch is at high level state, the MIC signal can turn into the computer while connected contrarily to the fifth switch, the control end is at the low level state, end;
The third switch is at low level state, the signal from the earphone to the mainboard of the Bluetooth is ended;
The fourth switch is at low level state, the LINE signal of the computer can't turn into the input end of the mainboard of the Bluetooth;
The fifth switch is at low level state, the MIC signal, which is outputted from the Bluetooth to the computer, is ended;
The sixth switch is at low level state, the signal, which is outputted from the Bluetooth to the telephone, is ended;
The seventh switch is at low level state, while without RING signal;
The eighth switch is at high level state, the LINE signal get through the power amplifier, and the feedback signal connected contrarily to the seventh switch, the control end is at low level state, end.

9. The converse method of the wireless earphone as claimed in claim 7, logical control circuit (6) controls the host circuit into the conversing state, the embodiment of the control way as follows:
The first switch is at low level state, the MIC signal can not turn into the telephone line;
The second switch is at low level state, the MIC signal can't turn into the computer;
The third switch is at low level state, the input signal from the earphone to the Bluetooth is ended;
The fourth switch is at high level state, the LINE signal of the computer turn into the mainboard of the Bluetooth, the signal connected contrarily to the third switch, and the control end is at low level state, end;
The fifth switch is at high level state, the MIC signal, which is outputted from the Bluetooth to the computer, gets through, the signal connected contrarily to the second switch, and the control end is at low level state, end, the signal connected contrarily to the sixth switch, and the control end is at low level state, end;
The sixth switch is at low level state, the signal, which is outputted from the Bluetooth to the telephone, is ended;
The seventh switch is at low level state, the telephone signal and the RING signal is ended;
The eighth switch is at low level state, the LINE signal from the computer to the power amplifier is switched off.

10. The converse method of the wireless earphone as claimed in claim 7, logical control circuit(6) controls the host circuit into waiting state, when the telephone be pulled, the embodiment of the control way as follows:
The first switch is at high level state, the MIC signal turns into the telephone line, the signal connected contrarily to the second switch, and at the low level state, end;
The second switch is at low level state, the signal is ended;
The third switch is at low level state, the signal from the earphone to the Bluetooth is ended;
The fourth switch is at low level state, the signal is ended;
The fifth switch is at low level state, the signal is ended;
The sixth switch is at low level state, the signal is ended;
The seventh switch is at high level state, the telephone signal turns into the power amplifier, it's impactful when the without holding up the earphone;
The eighth switch is at low level state, the signal is ended.

11. The converse method of the wireless earphone as claimed in claim 7, logical control circuit(6) controls the host circuit working with Bluetooth state, when the telephone be pulled, the embodiment of the control way as follows:
The first switch is at low level state, the signal is ended;
The second switch is at low level state, the signal is ended;
The third switch is at high level state, the signal from the earphone turns into the mainboard of the Bluetooth;
The fourth switch is at low level state, the signal is ended;
The fifth switch is at low level state, the signal is ended;
The sixth switch is at high level state, the signal from the Bluetooth turns into the telephone line;
The seventh switch is at low level state, the signal is ended;
The eighth switch is at low level state, the signal is ended.

12. The converse method of the wireless earphone as claimed in claim 7, logical control circuit(6) controls the host circuit into waiting state when calling in, the embodiment of the control way as follows:
The first switch is at high level state, the MIC signal is impactful to the telephone line;
The second switch is at low level state, the MIC signal to the computer is ended;
The third switch is at high level state, the signal from the telephone turns into the Bluetooth is ended;
The fourth switch is at low level state, the LINE signal from the computer turns into the Bluetooth is ended;
The fifth switch is at low level state, the signal from the Bluetooth to the computer is ended;
The sixth switch is at low level state, the signal from the Bluetooth turns into the telephone line is ended;
The seventh switch is at high level state, the telephone signal is impactful while it turning into power amplifier;
The eighth switch is at low level state, the computer signal is ended, while it turning into power amplifier.

13. The converse method of the wireless earphone as claimed in claim 7, logical control circuit(6) controls the host circuit work with Bluetooth state when calling in, the embodiment of the control way as follows:
The first switch is at low level state, the MIC signal is ended while it turning into the telephone line;
The second switch is at low level state, the MIC signal to the computer is ended;
The third switch is at high level state, the signal from the telephone turns into the Bluetooth is inpactful;
The fourth switch is at low level state, the LINE signal from the computer turns into the bluetooth is ended;
The fifth switch is at low level state, the signal from the Bluetooth to the computer is ended;
The sixth switch is at high level state, the signal from the Bluetooth turns into the telephone line is impactful;
The seventh switch is at low level state, the telephone signal is ended while it turning into power amplifier;
The eighth switch is at low level state, the computer signal is ended, while it turning into power amplifier.
